(19) United States
(12) Patent Application Publication
(10) Pub. No.: US 2008/0294456 A1
(43) Pub. Date: Nov. 27, 2008

(54) ASSEMBLIES AND METHODS FOR STORING, ORGANIZING, AND ADMINISTRATING PERSONAL MEDICATIONS

(76) Inventor: Sharon Grybinas, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/754,078

(22) Filed: May 25, 2007

(51) Int. Cl. G06Q 50/00

(52) U.S. Cl. 705/2

(57) ABSTRACT

A personal medications storage assembly and method of use for storing, organizing and administering medications for a patient. The assembly includes a base having an opening, a storage area, and a plurality of outer surfaces. At least one outer surface of the base includes standardized indicia uniquely identifying the assembly as a personal medications storage assembly. A lid is adapted for closing the opening of the base. A compartment is configured for receiving medication descriptive material associated with the medications placed within the storage area.

### FIELD

The present disclosure relates to administration of medicine by a patient and, more specifically, to containers and methods for storing, organizing and administering medicines by a patient or caregiver.

### BACKGROUND

The statements in this section merely provide background information related to the present disclosure and may not constitute prior art.

Generally there are many existing products for storing a patient's medications. Typically, many patients that have multiple medications store all of their medications in cardboard boxes such as a personally selected shoebox. These patients often place the medications in the box and may or may not include the medication descriptive material associated with the medications.

However, generally the existing personal medications storage devices are not easily used by patients and do not provide for storing of paper work and medical information related to the medications and the patient in a standard manner. Additionally, existing personal medications storage devices are not standardized such that they can be easily identified by a visiting medical care provider that does not have prior knowledge of the identification of the storage assembly used by a particular patient.

### SUMMARY

The inventor hereof has identified a need for a personal medication storage assembly that can solve some of the problems with existing medications storage methods and storage assemblies. The inventor has succeeded at designing assemblies and method for storing and administering personal medications and prescriptions that can provide for standardized storing and administration of medications for an individual and the easy identification of such a storing assembly and the medications and medication descriptive material associated with the medications. In some embodiments, such assemblies and methods can provide for reducing the time associated with identifying medications for a patient and subsequent delivery of appropriate medical care.

According to one aspect, a personal medications storage assembly for holding medications for a patient includes a base having an opening and defining a storage area therein, the base having a plurality of outer surfaces. At least one outer surface of the base includes standardized indicia uniquely identifying the storage assembly as a personal medications storage assembly. A lid is adapted for closing the opening of the base. A compartment is configured for receiving medication descriptive material associated with the medications placed within the storage area.

According to another aspect, a personal medications storage assembly for holding medications for a patient includes means for storing a plurality of medication containers, means for holding medication descriptive material associated with the medications stored by the means for storing and means for standardizing the unique identification of the storage assembly.

According to yet another aspect, a personal medications storage assembly for holding medications for a patient includes a base having an opening and defining a storage area therein, the base having a plurality of outer surfaces, wherein at least one outer surface includes standardized indicia uniquely identifying the storage assembly as a personal medications storage assembly. A lid is hingedly attached to the base and adapted for closing the opening. A latching mechanism is configured for selectively securing the lid in a closed position. A compartment is configured for receiving medication descriptive material associated with the medications placed within the storage area.

According to another aspect, a method of storing medications of a patient includes dispensing a standardized personal medications storage assembly to one or more patients, storing a plurality of medications in the storage assembly for each patient, and placing in a compartment of the assembly the personal medications descriptive material associated with the stored medications, the compartment being configure for receiving and holding medication descriptive material associated with the medications stored in the storage assembly for the particular patient.

According to still another aspect, a method of uniquely identifying medications of a patient includes distributing a personal medications storage assembly having standardized indicia of indication to a plurality of patients and storing patient specific medications in each of the personal medications storage assemblies. The method also includes placing medication descriptive material associated with the patient specific medications in a compartment of the storage assembly configured for receiving such medication descriptive material and identifying the personal medications storage assembly as the personal medications storage assembly of a particular one of the patients.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1A is a top perspective view of an opened personal medications storage assembly according to one exemplary embodiment.

FIG. 1B is a top perspective view of a closed personal medications storage assembly according to another exemplary embodiment.

FIGS. 2A and 2B are front views of two different personal medications storage assemblies according to two exemplary embodiments.

FIGS. 3A and 3B are back views of two different personal medications storage assemblies according to two exemplary embodiments.

FIGS. 4A and 4B are side views of two different personal medications storage assemblies according to two exemplary embodiments.

FIGS. 5A and 5B are bottom views of two different personal medications storage assemblies according to two exemplary embodiments.

FIG. 6A is a top perspective view of a closed personal medications storage assembly according to another exemplary embodiment.

FIG. 6B is a top perspective view of an open personal medications storage assembly according to another exemplary embodiment.

FIG. 6C is a front view of an open personal medications storage assembly according to one exemplary embodiment.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

In some embodiments, a personal medications storage assembly for holding medications for a patient includes a base having an opening, a storage area defined by walls having inner and outer surfaces. The base can be of any shape or dimensions that may be suitable for storing medications for a particular or group of patients. While typically a rectangular box shape may be more traditional, other shapes such as a round or cylinder shape may also be suitable. In some embodiments, the storage area is left open or is non-partitioned for placement of medicine containers such as boxes and bottles. In other embodiments, the storage area can be subdivided into compartments for storing the medicine. For example, individual medicine bottle compartments can be molded into the inner portion of the inner surfaces of the walls defining the storage area or inserted partitions can define the compartments. Such partitions can be permanent or removable, can be fixed or adjustable sizes and allow for customization, or can be equal or different sizes. The outer surfaces of the base can have a standardized color, such as red, such as to aid in the identification of the personal medications storage assembly.

Standardized indicia that uniquely identify the assembly as a personal medications storage assembly is provided on one or more outer surfaces of the base to also help in the unique identification of the assembly as a personal medications storage assembly. In some embodiments, the standardized indicia is or at least includes a medical cross prominently located one at least one outer surface. Such a medical cross could also have standardized colors. The standardized indicia can be common among a plurality of personal medication storage assemblies such that a visiting medical person can easily and readily identify the assembly in a patient's environment. For example, the standardized specification of such standardized indicia could be established by an organization providing medical care to a group of patients or by a government or quasi government or private entity who is responsible for ensuring medical care to a group of people or who provides the medications to the patients. By way of example, this can include, but is not limited to specification on a basis of a country, a state, a providence, a county, a medical institution, a pharmaceutical company, a whole medical supplier, and a retail medical supplier.

A lid is adapted for closing the opening of the base and has a shape and size as may be required by the shape and size of the base. By way of one example, the base and the lid can be configured to have a total outer dimension equal to about 10.75 inches wide, about 5.0 inches high, and about 6.0 inches deep. Of course other sizes and ratios to these dimensions are also possible and considered within the scope of the present disclosure.

The lid can also include one or more standardized indicia and can be color coordinated with the base. In some embodiments, the lid is detachable and is secured to the base by a press or joining fit. In other embodiments, lid is attached to the base, such as by way of one or more hinges or flexible attachments. It is also possible that in some embodiments, a latching mechanism such as a user selectively operable lock, by way of example, can provide for selectively securing the lid in a closed position thereby securing the contents therein.

The assembly also includes one or more compartments that are configured for receiving medication descriptive material associated with the medications placed within the storage area. The medication descriptive material can be any such material including paper or memory device and can include information such as an inventory of personal medications of the owner, a prescription, a dosage, a dosage frequency, a dosage history or log, by way of example.

The compartment can be located in or on the base or in and on the lid. Some examples of location of a compartment can include, but is not limited to, an underside of the lid, in the storage area, on one of the outer surfaces of the compartment, and on an outer surface of the lid. The compartment can be defined by one or more features, such as slots, pockets, sleeves, holes or otherwise. The compartment can be formed in the storage area such as by a partition or can be formed by a substantially transparent protective covering. Such an embodiment can enable the easy identification of the contents of the medication descriptive materials.

The assembly can also include a handle extending from an outer surface of at least one of the base and the lid. The handle can be fixed, pivotal, flexible, or removable. In some embodiments, the assembly can include a mounting feature, such as a hook, ledge, or otherwise, for easily mounting the personal medications assembly on a wall or similar mounting surface.

Additionally, patient identification indicia such as the name of the patient can be prominently displayed on an outer surface of the base and/or the lid for easy and unique identification of the patient and/or the personal medications storage assembly.

In some embodiments, a passive or active RFID tag containing patient identification indicia can be included for storing the name of the patient, patient data, medication data, etc, such as any and all of the medication descriptive material. In these embodiments, medical personal can utilize an RFID reader for activating and reading the stored medication descriptive material while in the proximity to the assembly.

Similarly, in other embodiments an active or passive locating mechanism can be included in the assembly for aiding in the locating and identification of the personal medications storage assembly. The locating mechanism can be configured to respond to an identification request signal initiated by visiting medical personnel to further aid in the location of the assembly. This can include the generation of a location identifier such as a light, an audible alert signal, a vibration or a message.

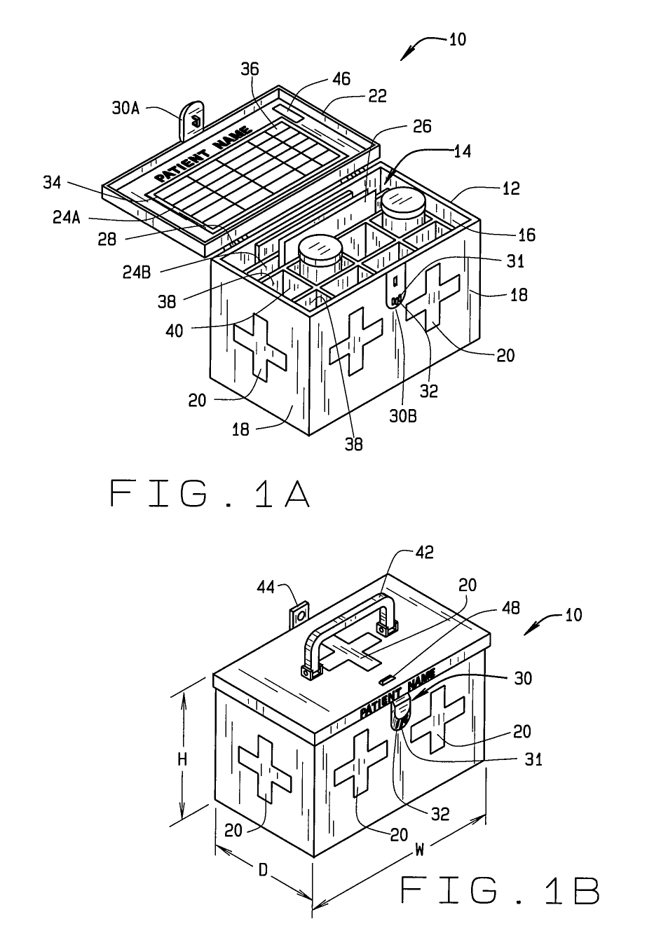

One exemplary embodiment of a personal medications storage assembly 10 is provided in FIGS. 1A and 1B. In this example, a base 12 has a box shape and defines an opening 14 and a storage area 16. Sidewalls include outer surfaces 18. Standardized indicia 20, showing as medical crosses, are located on the outer surfaces 18 that uniquely identify the base 12 as the personal medications storage assembly 10. While not illustrated in the drawings of FIGS. 1A and 1B, the outer surfaces 18 can be any color and in some embodiments are a standardized red. The standardized indicia 20 can be any color and in some embodiments are white. The storage area 16 can be open and non-obstructed or can include fixed, removable, or adjustable compartments 38 as may be defined by one or more partitions 40 as shown by way of example in FIG. 1A. When provided, each compartment 38 can be configured for holding a different medication container and can be of equal size or of different sizes to enable the storing of different size medication containers. Additionally, the number of compartments 38 can be fixed or can vary. In some embodiments, the number of compartments 38 is between eight (8) and fourteen (14), and in one embodiment is twelve (12).

A lid 22 is dimensioned and adapted for enclosing the opening 16 for sealing the base 12. A storage compartment 24 is located on the assembly for receiving and storing medication descriptive material 26. In this example, two storage compartments 24 are illustrated, however, one or more storage compartments 24 can be provided. As shown, a first storage compartment 24A is located under the lid 22 and includes a dosage schedule or log. A second storage compartment 24B is located in the storage area 16. As noted above, one or both of these may be present, or may be located on a different location of the base 12 or the lid 22. As shown in the example, the first storage compartment 24A can include a transparent or partially transparent protective covering 34 in whole or in part defining the storage compartment 24. In some embodiments, the storage compartment 24 can include a sleeve 36 that is configured to receive the medication descriptive material 26. In other embodiments, the storage compartment 24 can be a partitioned location, such as shown in FIG. 1A as compartment 24B. This can provide for storing of any of the medication descriptive material 26, including drug descriptions and interaction material as provided by the pharmacy at the time the prescription is filled.

In this example, hinges 28 flexibly attach the lid 22 to the base 12 for enabling the lid 22 to be opened, as in FIG. 1A, and closed, as in FIG. 1B. This can be advantageous in some embodiments where the storage compartment 24 is located on the underside of the lid 22.

A latch mechanism 30 can also be provided for securing the lid 22 in a closed position. Generally latch mechanisms 30 are known to those skilled in the art and can have a first latching portion 30A that is attached or formed in the lid 22, such as a protrusion or a tongue. A second latching portion 30B is associated with the base 12 and is adapted for engaging and selectively securing the first latching portion 30A. The latch mechanism 30 can be a hook and latch arrangement or can be a lock 32 as shown in FIGS. 1A and 1B. Additionally, the latch mechanism can include a user input 31 such as a keyhole or a rotary combination for the lock 32 that is configured to receive a male or female interlocking feature of the first portion 30A.

The assembly 10 can also include a handle 42 to enable the easy transport of the assembly 10. The handle 42 can be located on the lid 22 or on the base 12 and can be fixed, pivotal, flexible, or removable. One or more mounting features 44 can also be provided for hanging or otherwise mounting the assembly 10 to a wall or other surface. As shown in FIG. 1B, the mounting feature can be a tab with a hole for hanging on a nail, screw or hook.

As noted above, the dimensions of the assembly 10 can be of any size and shape. This can include any width W, depth D, and height H as shown for the box-shaped exemplary embodiment of FIGS. 1A and 1B.

Additionally, an RFID tag 46 can be located on the base 12, the lid 22 or the handle 42. The RFID tag 46 can be passive or active. The RFID tag 46 can include stored patient or medication descriptive information.

Also as noted above, a locating mechanism 48 can be provided. The locating mechanism 48 can be configured with a receiver for receiving a location activation signal and a generator for generating a location identification signal, message, light, or alarm, by way of examples.

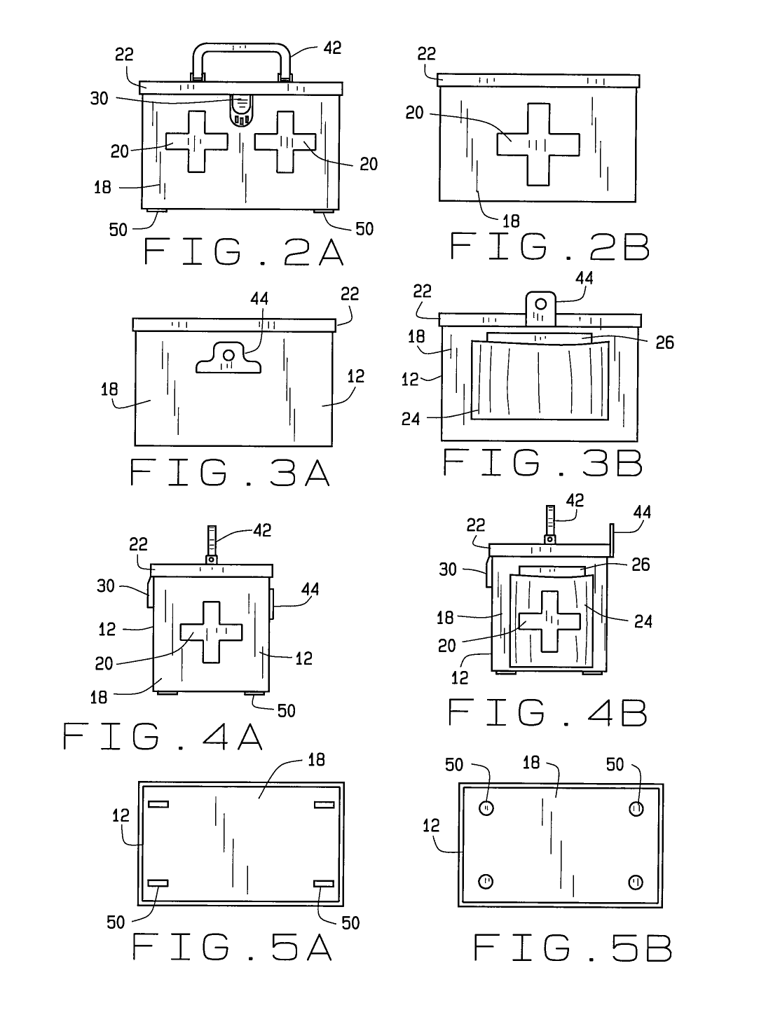

FIGS. 2A and 2B illustrated two additional exemplary illustrations of front views of assemblies 10. As shown in FIG. 2A, mounting feet 50 can also be provided for mounting the assembly 10 on a surface or for protecting a mounting surface. FIG. 2B illustrates an embodiment where the lid 22 is coupled to the base 12 by a pressure fitting and not by means of a hinge or latching mechanism as illustrated in FIGS. 1A, 1B, and 2A. FIGS. 3A and 3B illustrated two different back views of the assembly 10. In FIG. 3A the mounting feature 44 is attached to the back surface 18 of the base 12. In FIG. 3B the mounting feature 44 is attached to the lid 22. In other embodiment, one or more additional mounting features 44 can be positioned on or incorporated into additional locations or outer surface 18 and still be within the scope of the present disclosure.

FIGS. 4A and 4B illustrated two exemplary side views of the assembly 10. FIG. 4A illustrated an assembly with a flexible handle 42 and mounting feet 50 with the indicia 20 on the side surface 18. FIG. 4B illustrates a compartment 24 located on an outer surface 18 on the side of the assembly 10. Such compartment 24 can include the transparent protective cover 24 that defines the sleeve 36 for holding the medication descriptive material while also enabling a user to see the contents of such or to read one or more of the medication descriptive material without having to remove such from the compartment 24.

FIGS. 5A and 5B provide two examples of different bottom views of the assembly 10 having two different exemplary patterns of mounting feet 50.

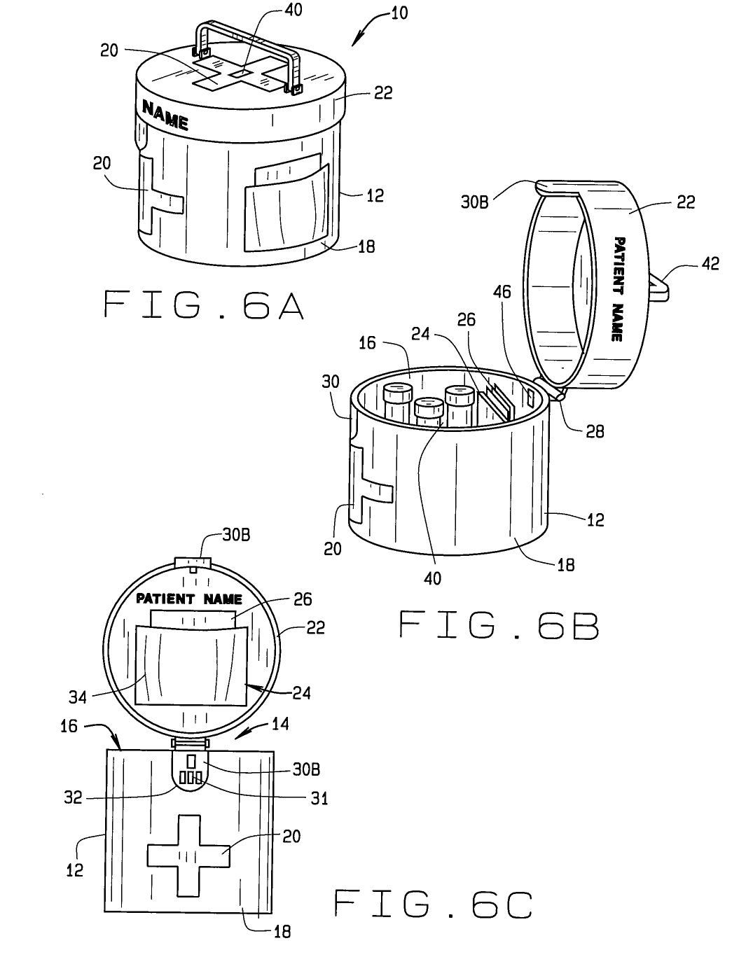

As noted above, the assembly 10 can have shapes other than a box shape. FIGS. 6A, 6B, and 6C provide an additional exemplary embodiment of an assembly 10 that has a round shape. Of course, as known to those skilled in the art, other shapes are also possible and this disclosure is not limited to the illustrated box and round shapes of the exemplary embodiments of the Figures. As noted, the compartment 24 can be located on an outer surface 18 as shown in FIG. 6A, in the storage area 16 as shown in FIG. 6B, or on the underside of the lid 22 as shown in FIG. 6C.

In operation, one or more embodiments of the personal medical storage assembly as described herein can be utilized for storing medications of a patient. A standardized medications storage assembly can be dispensed to a patient from among a plurality of such standardized medications storage assemblies. Patient specific medications are stored in the storage assembly for the patient. Additionally, personal medications descriptive material associated with the stored medications for the particular patient is stored in a compartment of the assembly.

Generally, at a later time, someone attending to the patient may need to find the personal medications storage assembly for providing medication attention or care. Such medical care provider would identify the personal medications storage assembly as the personal medications storage assembly of the particular patient to ensure that proper care is provided. The medical care provider would retrieve the stored patient specific medications descriptive material from the compartment of the storage assembly following the identification of the medications storage assembly as containing the personal medications storage assembly of the particular patient. Where provided, the medical care provider could generate an activating signal that would activate an identification signal of the assembly. In this manner, the assembly could be quickly located and identified. The medications descriptive material could also be provided in electronic form directly from an RFID tag or another form of electronic data storage.

Additionally, in some operations a method of uniquely identifying medications of a patient can include distributing a personal medications storage assembly having standardized indicia of indication to a plurality of patients and storing patient specific medications in each of the personal medications storage assemblies. The method also includes placing medication descriptive material associated with the patient specific medications in a compartment of the assembly configured for receiving such medication descriptive material and identifying the personal medications storage assembly as the personal medications storage assembly of a particular one of the patients.

This can also include dispensing a plurality of medications to a patient and distributing the personal medications storage assembly in conjunction with the dispending of the medications. For example, a patient can receive a supply of medications from a pharmacy and the pharmacy can provide those medications in the personal medications storage assembly including the patient specific medications descriptive material in the compartment. This can also include storing such material in an electronic storage device, memory or RFID tag. Additionally, in some embodiments, the patient can be provided a complete set of medications for a particular period of time in the personal medications storage assembly. The medications provider can package the complete set of medications and the medications descriptive material in the personal medications storage assembly for each of transport and use by the patient.

Later on, a medical care provider attending to the patient would be able to easily locate the personal medications storage assembly associated with a particular patient and then retrieve the stored patient specific medications descriptive material from the compartment of the storage assembly following the identification of the medications storage assembly as containing the medications of the particular patient.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

1. A personal medications storage assembly for holding medications for a patient comprising:
a base having an opening and defining a storage area therein, the base having a plurality of outer surfaces, wherein at least one outer surface includes standardized indicia uniquely identifying the assembly as a personal medications storage assembly;
a lid is adapted for closing the opening of the base; and
a compartment configured for receiving medication descriptive material associated with the medications placed within the storage area.

2. The assembly of claim 1 wherein the lid is hingedly attached to the base.

3. The assembly of claim 1, further comprising a latching mechanism for selectively securing the lid in a closed position.

4. The assembly of claim 3 wherein the latching mechanism includes a lock for locking the latching mechanism.

5. The assembly of claim 1 wherein the standardized indicia includes a medical cross prominently located one at least one outer surface and wherein the outer surfaces of the base and an outer surface of the lid have a standardized color of red and the medical cross is white.

6. (canceled)

7. The assembly of claim 1 wherein the compartment is located on a location selected from the group consisting of an underside of the lid, in the storage area, on one of the outer surfaces of the compartment, and on an outer surface of the lid.

8. The assembly of claim 7 wherein the compartment includes a substantially transparent protective covering.

9. The assembly of claim 1 wherein the storage area includes a plurality of individual medicine bottle compartments defined by two or more partitions, each medicine bottle holding compartments configured for holding a separate medicine bottle.

10. The assembly of claim 1, further comprising a handle extending from an outer surface of at least one of the base and the lid.

11. The assembly of claim 1, further comprising a mounting feature configured for mounting the assembly on a wall.

12. (canceled)

13. The assembly of claim 1, further comprising a locating mechanism configured to respond to an identification request signal.

14. (canceled)

15. A personal medications storage assembly for holding medications for a patient comprising:
means for storing a plurality of medication containers;
means for holding medication descriptive material associated with the medications stored by the means for storing; and
means for standardizing the unique identification of the storage assembly.

16. A personal medications storage assembly for holding medications for a patient comprising:
a base having an opening and defining a storage area therein, the base having a plurality of outer surfaces, wherein at least one outer surface includes standardized indicia uniquely identifying the assembly as a personal medications storage assembly;
a lid hingedly attached to the base and adapted for closing the opening;
a latching mechanism for selectively securing the lid in a closed position; and
a compartment configured for receiving medication descriptive material associated with the medications placed within the storage area.

17. The assembly of claim 16 wherein the standardized indicia includes a medical cross prominently located one at least one outer surface.

18. The assembly of claim 16 wherein the compartment is located at a location selected from the group consisting of an underside of the lid, in the storage area, on one of the outer surfaces of the base, on an outer surface of the lid.

19. The assembly of claim 16 wherein the storage area includes a plurality of individual medicine bottle compartments defined by two or more partitions, each medicine bottle holding compartments configured for holding a separate medicine bottle.

20. The assembly of claim 16, further comprising a handle extending from an outer surface of at least one of the base and the lid.

21. A method of storing medications of a particular patient comprising:
dispensing a personal medications storage assembly to the particular patient from a group of standardized storage assemblies;
storing a plurality of medications in the personal medications storage assembly for the patient; and
placing in a compartment of the assembly medication descriptive material associated with the stored medications, the compartment being configure for receiving and holding medication descriptive material.

22. The method of claim 21, further comprising identifying the personal medications storage assembly as the medications storage assembly of the particular patient.

23. The method of claim 22, further comprising retrieving the stored patient specific medications descriptive material from the compartment of the personal medications storage assembly following the identification of the assembly as the personal medications storage assembly containing the medications of the particular patient.

24. The method of claim 22, further comprising activating an identification signal in a proximity to the patient, wherein identifying the personal medications storage assembly is responsive to activating the identification signal.

25. (canceled)

26. A method of uniquely identifying medications of a patient comprising:
distributing personal medications storage assemblies having a standardized indicia of indication to a plurality of patients;
storing patient specific medications in each of the personal medications storage assemblies;
placing medication descriptive material associated with the patient specific medications in a compartment of the assembly configured for receiving such medication descriptive material; and
identifying the personal medications storage assembly as the personal medications storage assembly of a particular one of the patients.

27. The method of claim 26, further comprising dispensing a plurality of medications to a patient, wherein distributing the personal medications storage assembly is associated with the dispending of the medications.

28. The method of claim 26, further comprising retrieving the stored patient specific medications descriptive material from the compartment of the personal medications storage assembly following the identification of the personal medications storage assembly as containing the medications of the particular patient.

29. (canceled)

30. The method of claim 26, further comprising activating an identification signal in a proximity to a particular patient, wherein identifying the personal medications storage assembly is responsive to activating the identification signal.

31. (canceled)
